(19) United States
(12) Patent Application Publication
(10) Pub. No.: US 2002/0148159 A1
(43) Pub. Date: Oct. 17, 2002

(54) Pot cover having an elastic portion

(76) Inventor: Donald E. Weder, Highland, IL (US)

Correspondence Address: Christopher W. Corbett, Dunlap, Codding & Rogers, P.C., Suite 420, 9400 North Broadway, Oklahoma City, OK, 73114, US

(21) Appl. No.: 10/124,811

(22) Filed: Apr. 10, 2002

Related U.S. Application Data
(63) Continuation-in-part of application No. 09/651,567, filed on Aug. 29, 2000, now Pat. No. 6,385,905.
Application No. 09/651,567 is a continuation-in-part of application No. 09/401,771, filed on Sep. 22, 1999, now Pat. No. 6,230,441.
Application No. 09/401,771 is a continuation of application No. 08/606,957, filed on Feb. 26, 1996, now abandoned.

(51) Int. Cl. A01G 9/02

(52) U.S. Cl. 47/72

(57) ABSTRACT

A cover for covering a floral container such as a flower pot, the cover having a lower portion constructed from an elastic material which can be stretched about the bottom of a floral container, to secure the cover about the floral container.

### CROSS REFERENCE TO RELATED APPLICATIONS

The present application is a continuation-in-part of U.S. Ser. No. 09/651,567, filed Aug. 29, 2000, which is a continuation-in-part of U.S. Ser. No. 09/401,771, filed Sep. 22, 1999, now U.S. Pat. No. 6,230,441, which is a continuation of U.S. Ser. No. 08/606,957, filed Feb. 26, 1996, now abandoned, the specifications of each of which are hereby expressly incorporated by reference herein.

### BACKGROUND

The present invention pertains to, but is not limited to, the field related to sleeves or covers used to cover floral containers such as pots, or to the field related to containers used to contain plants or floral groupings. U.S. Pat. No. 5,625,979 contains subject matter which may be related to that of the present invention and is hereby expressly incorporated herein by reference in its entirety.

### BRIEF DESCRIPTION OF THE DRAWINGS

FIG. 1 is an elevational view of a floral sleeve constructed in accordance with the present invention.

FIG. 2 is a cross-sectional view of the floral sleeve of FIG. 1 taken along line 2-2.

FIG. 3 is a cross-sectional view of the floral sleeve of FIG. 1 having a pot disposed therein.

FIG. 4 is an elevational view of another floral sleeve constructed in accordance with the present invention.

FIG. 5 is a cross-sectional view of the floral sleeve of FIG. 4 taken along line 5-5.

FIG. 6 is an elevational view of another floral sleeve constructed in accordance with the present invention.

FIG. 7 is a cross-sectional view of the floral sleeve of FIG. 6 taken along line 7-7.

FIG. 8 is a cross-sectional view of yet another floral sleeve constructed in accordance with the present invention wherein the floral sleeve is in a substantially flattened state.

FIG. 9 is an elevational view of another floral sleeve constructed in accordance with the present invention.

FIG. 10 is a cross-sectional view of the floral sleeve of FIG. 9 taken along line 10-10.

FIG. 11 is an elevational view of another floral sleeve constructed in accordance with the present invention.

### DETAILED DESCRIPTION OF THE INVENTION

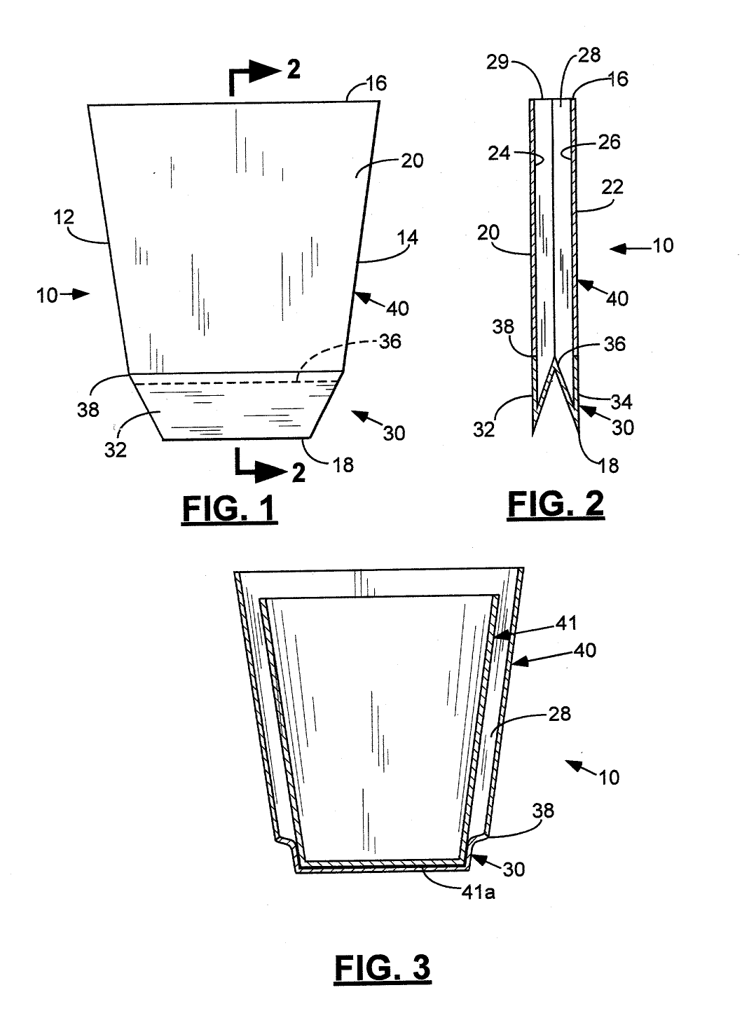

Turning now to the drawings, shown in FIGS. 1 and 2 and designated therein by the general reference numeral 10, is a preformed floral sleeve (also referred to herein as a sleeve, floral sleeve, or cover) having a first side 12, a second side 14, an upper end 16, a lower end 18, a first panel 20, and a second panel 22. The floral sleeve 10 is initially formed in a flattened condition (FIG. 1) and is openable to have a generally tubular shape, preferably a tapered, inverted frustoconical shape as shown in FIG. 3. It will be appreciated, however, that the floral sleeve 10 may comprise variations on the aforementioned shapes or may comprise significantly altered shapes such as square or rectangular, as long as the floral sleeve 10 functions in accordance with the present invention in the manner described herein. The floral sleeve 10 further comprises a first inner peripheral surface 24, a second inner peripheral surface 26, an inner retaining space 28 and an upper opening 29.

The floral sleeve 10 further comprises a lower portion 30 which forms an elastic portion which comprises a first elastic portion 32, a second elastic portion 34 and an elastic gusset portion 36. The first elastic portion 32 comprises a lower portion of the first panel 20 and the second elastic portion 34 comprises a lower portion of the second panel 22. Extending from an upper end 38 of the lower portion 30 to the upper end 16 of the floral sleeve 10 is an upper portion 40 which comprises that portion of the floral sleeve 10 which is not constructed of the same elastic material used to construct the lower portion 30. The upper portion 40 may be constructed of a material having a slight degree of elasticity, such as a polypropylene film; however, the upper portion 40 has significantly less elasticity than the lower portion 30. Preferably, the lower portion 30 is constructed from a material which has elastic properties such that when a floral container, such as a flower pot 41 having a bottom 41a is disposed within the inner retaining space 28 of the floral sleeve 10, the lower portion 30 expands to conform to the shape and bottom 41a of the flower pot 41, thereby “gripping” the flower pot 41 wherein the floral sleeve 10 is held about the flower pot 41. In particular, the elastic material used to construct the lower portion 30 may comprise a natural or synthetic rubber, or a rubberized material such as a latex-coated or impregnated fabric. Elastic polyurethanes, such as spandex or a fabric made with spandex, may also be used.

In one embodiment of the present invention as shown in FIG. 3, the upper portion 40 may be oversized such that when the floral sleeve 10 is placed about the flower pot 41, the upper portion 40 is loose about the flower pot 41 and it is only by virtue of the gripping connection of the lower portion 30 to the flower pot 41 that the floral sleeve 10 can be secured about the flower pot 41 without an additional attaching element such as a string, tie, ribbon, wire, or adhesive or cohesive bonding material. Preferably, the lower portion 30 covers the entire bottom 41a of the flower pot 41. The lower portion 30 may be connected to the upper portion 40 via a butt seal, a seam seal, a lap seal, a fin seal, or any adhesion or sealing technique which is effective in connecting the elastic material of the lower portion 30 to the material from which the upper portion 40 is constructed.

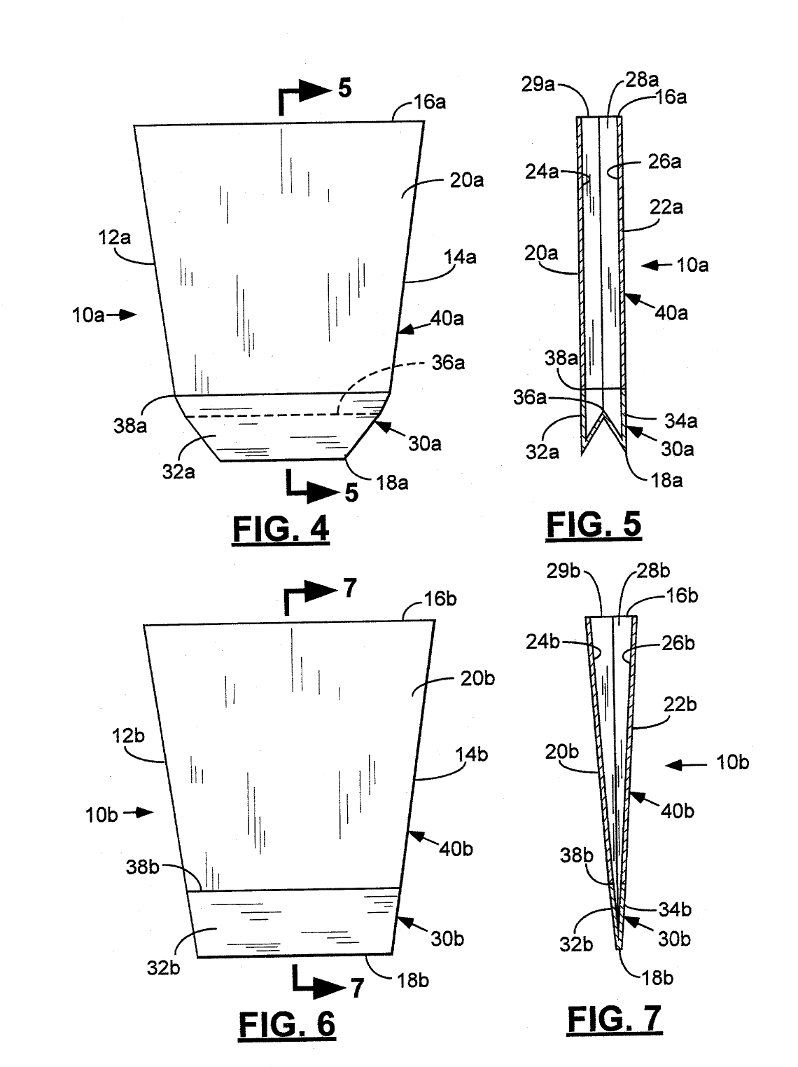

Shown in FIGS. 4 and 5 is another version of a sleeve of the present invention designated by the general reference numeral 10a. Sleeve 10a is similar to sleeve 10 described in detail above, and has a first side 12a, a second side 14a, an upper end 16a, a lower end 18a, a first panel 20a, a second panel 22a, a first inner peripheral surface 24a, a second inner peripheral surface 26a, an inner retaining space 28a, an upper opening 29a, a lower portion 30a having a first elastic side 32a, a second elastic side 34a, an elastic gusset portion 36a, an upper end 38a of the lower portion 30a, and an upper portion 40a which extends from the upper end 38a of the lower portion 30a. Sleeve 10a differs from sleeve 10 in that the upper end 38a of the lower portion 30a extends higher on the first panel 20a and on the second panel 22a than the upper end 38 extends on the first panel 20 and on the second panel 22 of sleeve 10. In this manner the lower portion 30a of the sleeve 10a can extend higher above the bottom 41a of the flower pot 41 when the sleeve 10a is disposed about the flower pot 41.

Shown in FIGS. 6 and 7 is another version of a sleeve of the present invention designated by the general reference numeral 10b. Sleeve 10b is similar to sleeves 10 or 10a described in detail above and has a first side 12b, a second side 14b, an upper end 16b, a lower end 18b, a first panel 20b, a second panel 22b, a first inner peripheral surface 24b, a second inner peripheral surface 26b, an inner retaining space 28b, an upper opening 29b, a lower portion 30b having a first elastic side 32b, a second elastic side 34b, an upper end 38b of the lower portion 30b, and an upper portion 40b which extends from the upper end 38b of the lower portion 30b.

Sleeve 10b differs from sleeves 10 and 10a in that the lower portion 30b does not comprise a gusset portion; instead, the lower end 18b has a straight seal thereacross.

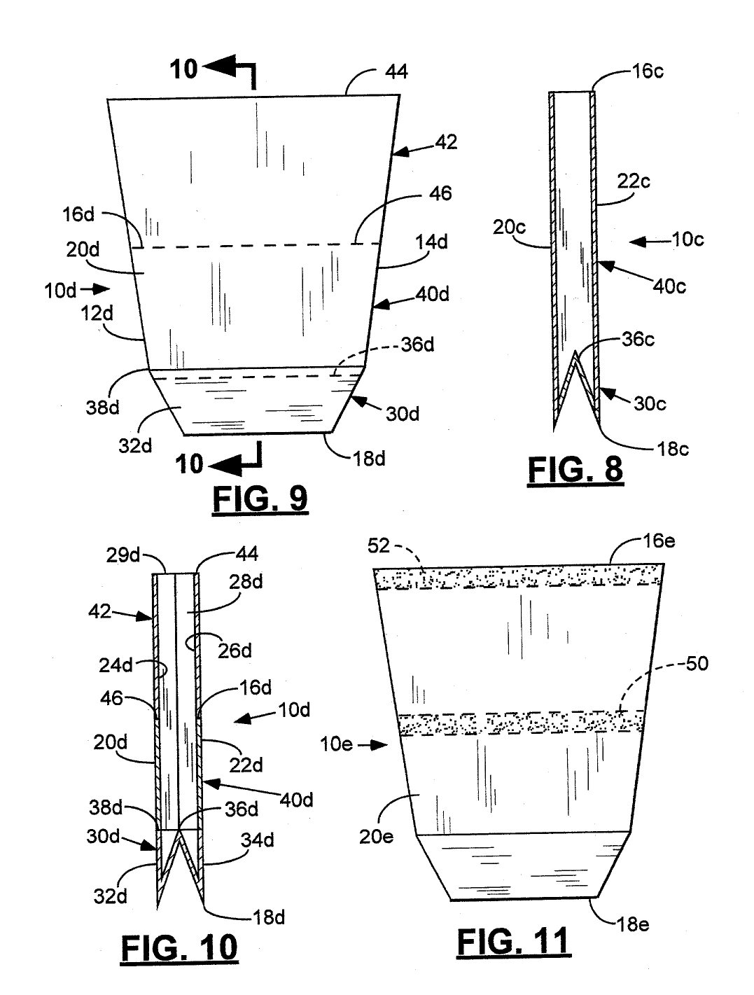

Shown in FIG. 8 is another version of a sleeve of the present invention designated by the general reference numeral 10c. Sleeve 10c has an upper end 16c, a lower end 18c, a first panel 20c, a second panel 22c, a lower portion 30c, a gusset portion 36c and an upper portion 40c. Sleeve 10c differs from sleeves 10 and 10a primarily in that the only portion of the lower portion 30c which comprises an elastic material is the gusset portion 36c. That is, first panel 20c and second panel 22c are substantially free of the elastic material used in the construction of the gusset portion 36c except for marginal portions at the lower end 18c where the gusset portion 36c is sealed to or otherwise attached to the first panel 20c and the second panel 22c.

Shown in FIGS. 9 and 10 is another version of a sleeve of the present invention designated by the general reference numeral 10d. Sleeve 10d is similar to sleeve 10 described in detail herein and has a first side 12d, a second side 14d, an upper end 16d, a lower end 18d, a first panel 20d, a second panel 22d, a first inner peripheral surface 24d, a second inner peripheral surface 26d, an inner retaining space 28d, an upper opening 29d, a lower portion 30d having a first elastic portion 32d, a second elastic portion 34d, an elastic gusset portion 36d, an upper end 38d of the lower portion 30d, and an upper portion 40d which extends from the upper end 38d of the lower portion 30d. Sleeve 10d differs from sleeve 10 in that sleeve 10d further comprises a detachable extension 42 having an upper end 44. The extension 42 is attached to the upper end 16d of the upper portion 40d and is detachable from the upper portion 40d via a detaching element 46 which in a preferred embodiment is a line of perforations as indicated in FIG. 9. The detaching element 46 may be perforations, a zipper, a tear strip, or any other detaching mechanism known to a person of ordinary skill in the art. The extension 42 may be sized to surround and encompass a floral grouping disposed in and extending from a flower pot for the purpose of protecting the floral grouping or may extend from the upper portion 40d only a distance sufficient to enable the extension 46 to be used as a support member to support the sleeve 10d from a support assembly such as a wicket, staple, or other support assembly known to a person of ordinary skill in the art.

FIG. 11 shows a sleeve designated by the general reference number 10e which is similar to sleeve 10 and having an upper end 16e, a lower end 18e, a first panel 20e and a second panel (not shown) and having an inner surface (not shown). Sleeve 10e has a first bonding material 50 disposed on a portion of the inner surface thereof and a second bonding material 52 disposed on a portion of the inner surface near the upper end 16e.

The first bonding material 50 may be used to assist in connecting or securing the sleeve 10e to a flower pot having a floral grouping therein when such a flower pot is disposed within the sleeve 10e. The second bonding material 52 may be used to assist in closing or sealing the upper end 16e of the sleeve 10e after the flower pot 41 has been disposed, therein for, example in the manner shown in U.S. Pat. No. 5,493,809, which is hereby incorporated by reference herein in its entirety. Each of sleeves 10-10d may be modified to have a bonding material disposed thereon in a similar manner.

It will be understood that the bonding material 50 or 52, when used, may be disposed as a strip or block on a surface of the sleeve 10e. The bonding material 50 or 52 may be covered by a cover or release strip (not shown) which can be removed prior to the use of the sleeve, pot or pot cover.

In yet another embodiment of the present invention, a sheet of material (not shown) could be formed about a flower pot before the floral sleeves 10-10e are placed about the flower pot, with the floral sleeves 10-10e serving to secure the sheet of material in a position formed about the flower pot.

The floral sleeves 10-10e defined herein may form part of a plant package when used in conjunction with a flower pot disposed therein, or with the flower pot also having a floral grouping disposed therein, and wherein the flower pot is substantially surrounded and encompassed by a lower portion 30 and an upper portion of a sleeve, such as shown in FIG. 3 wherein the flower pot 41 is substantially surrounded and encompassed by a lower portion of the upper portion 40 of the sleeve 10. Preferably, the bottom 41a of the flower pot 41 is completely covered by the lower portion 30 of the sleeve 10.

The sleeves 10-10e may also be equipped with a drainage element (e.g., one or more holes) in the lower portion thereof or ventilation holes (not shown) or can be made from permeable or impermeable materials.

Preferably the sleeves 10-10e are sized to contain and conform to one of a variety of standard sizes of flower pots known to those of ordinary skill in the art, such as 3-inch, 4-inch, 4½-inch, 5-inch, 6-inch, and 8-inch flower pots. In fact, the floral sleeves 10-10e may be used to contain a floral grouping and a growing medium without the use of a flower pot 41 for cultivating a floral grouping or displaying a grown floral grouping.

The upper ends 16-16e of the sleeves 10-10e, respectively, contemplated herein may have a variety of patterns, including straight and nonlinear. When non-linear, the upper end 16-16e may be wavy, sinusoidal, scalloped, crenulate, crenelate, zig-zagged, or toothed, in any regular or irregular pattern as shown in U.S. Pat. No. 5,493,809 (FIGS. 26-31), the specification of which is hereby expressly incorporated herein in its entirety.

The term “floral grouping,” as used herein, means cut fresh flowers, artificial flowers, a single flower or other fresh and/or artificial plants or other floral materials and may include other secondary plants and/or ornamentation or artificial or natural materials which add to the aesthetics of the overall floral grouping. The floral grouping may comprise a bloom or foliage portion and a stem portion. Further, the floral grouping may comprise a growing potted plant having a root portion (not shown) as well. However, it will be appreciated that the floral grouping may consist of only a single bloom or only foliage, or a botanical item (not shown), or a propagule (not shown). The term “floral grouping” may be used interchangeably herein with both the terms “floral arrangement”. The term “floral grouping” may also be used interchangeably herein with the terms “botanical item” and/or “propagule.”

The term “growing medium,” when used herein, means any liquid, solid or gaseous material used for plant growth or for the cultivation of propagules, including organic and inorganic materials such as soil, humus, perlite, vermiculite, sand, water, and including the nutrients, fertilizers or hormones or combinations thereof required by the plants or propagules for growth.

The term “botanical item,” when used herein, means a natural or artificial herbaceous or woody plant, taken singly or in combination. The term “botanical item” also means any portion or portions of natural or artificial herbaceous or woody plants including stems, leaves, flowers, blossoms, buds, blooms, cones, or roots, taken singly or in combination, or in groupings of such portions such as bouquet or floral grouping.

The term “propagule,” when used herein, means any structure capable of being propagated or acting as an agent of reproduction including seeds, shoots, stems, runners, tubers, plants, leaves, roots or spores.

The term “bonding material,” when used herein, means an adhesive, frequently a pressure sensitive adhesive, or a cohesive. When the bonding material is a cohesive, a similar cohesive material must be placed on the adjacent surface for bondingly contacting and bondingly engaging with the cohesive material. The term “bonding material” also includes materials which are heat sealable and, in this instance, the adjacent portions of the material must be brought into contact and then heat must be applied to effect the seal. The term “bonding material” also includes materials which are sonic sealable and vibratory sealable. The term “bonding material” when used herein also means a heat sealing lacquer or hot melt material which may be applied to the material and, in this instance, heat, sound waves, or vibrations, also must be applied to effect the sealing.

It will be understood by a person of ordinary skill in the art that equipment and devices for forming floral sleeves such as those contemplated herein are commercially available, and are well known to a person of ordinary skill in the art. For example, the sleeves described herein may be formed by advancing two separate webs, one or two webs preformed in the form of a tube, or a single web folded double and sealing the longitudinal sides and bottom of the two facing panels then cutting the sleeve thus formed from the webs or web. Machines which can form sleeves from such single webs or pairs of webs are well within the knowledge of one of ordinary skill in the art.

The term “flower pot” is used interchangeably with the term “floral container” and as used herein, refers to any type of container used for holding a floral grouping or plant. Examples of flower pots, used in accordance with the present invention include, but not by way of limitation, clay pots, wooden pots, plastic pots, pots made from natural and/or synthetic fibers, or any combination thereof. The flower pot is adapted to receive a floral grouping in the retaining space. The floral grouping may be disposed within the flower pot along with a suitable growing medium as described herein, or other retaining medium, such as a floral foam. It will also be understood that the floral grouping, and any appropriate growing medium or other retaining medium, may be disposed in the floral sleeves 10-10e without a pot.

Changes may be made in the construction and the operation of the various components, elements and assemblies described herein or in the steps or the sequence of steps of the methods described herein without departing from the spirit and scope of the invention as defined in the following claims.

What is claimed is:

1. A cover for a floral container, comprising:
an upper end, a lower end, a lower portion and an upper portion extending from the lower portion to the upper end of the cover, at least a portion of the lower portion of the cover being constructed of an elastic material so that at least a portion of the lower portion of the cover can be stretched when a floral container having an upper end, a shape, and a bottom is disposed within the cover wherein the lower portion stretches and thereby substantially conforms to the bottom of the floral container and wherein the elastic material which comprises the lower portion is a different material than the material from which the upper portion of the cover is constructed.

2. The cover of claim 1 wherein the lower portion further comprises a gusset.

3. The cover of claim 1 having a frustoconical shape.

4. The cover of claim 1 wherein the lower portion is sized to completely cover the bottom of the floral container.

5. The cover of claim 1 wherein the elastic material is a natural or synthetic rubber or a rubberized material.

6. The cover of claim 1 wherein the elastic material is an elastic polyurethane.

7. The cover of claim 1 further comprising a detachable extension extending from the upper end of the cover.

8. The cover of claim 7 wherein the detachable extension is sized to substantially surround and encompass a floral grouping.

9. The cover of claim 1 wherein the lower portion is attached to the upper portion by a seam seal, a fin seal or a butt seal.

10. A method of covering a floral container, comprising:
providing a cover having an upper end, a lower end, a lower portion and an upper portion extending from the lower portion to the upper end of the cover and openable from the flattened state, the lower portion at least partially constructed from an elastic material, the elastic material comprising a different material than the material from which the upper portion of the cover is constructed;
providing a floral container having an upper end, a bottom and a shape; and
disposing the floral container into the cover wherein the lower portion of the cover stretches and thereby substantially conforms to the bottom of the floral container.

11. The method of claim 10 wherein in the step of providing a cover, the lower portion of the cover further comprises a gusset.

12. The method of claim 10 wherein in the step of providing a cover, the cover has a frustoconical shape.

13. The method of claim 10 wherein in the step of providing a cover, the lower portion of the cover is sized to completely cover the bottom of the floral container.

14. The method of claim 10 wherein in the step of providing a cover, the elastic material of the lower portion is a natural or synthetic rubber or a rubberized material.

15. The method of claim 10 wherein in the step of providing a cover, the elastic material of the lower portion is an elastic polyurethane.

16. The method of claim 10 wherein in the step of providing a cover, the cover further comprises a detachable extension.

17. The method of claim 16 wherein in the step of providing a cover, the detachable extension is sized to substantially surround and encompass a floral grouping.

18. The method of claim 10 wherein in the step of providing a cover, the lower portion of the cover is attached to the upper portion of the cover by a seam seal, a fin seal or a butt seal.
